(19) United States
(12) Patent Application Publication
(10) Pub. No.: US 2023/0412413 A1
(43) Pub. Date: Dec. 21, 2023

(54) MANAGEMENT OF USER'S INCOMING IMAGES IN VIDEOCONFERENCE SESSIONS

(71) Applicant: Viktor Kaptelinin, Hornefors (SE)

(72) Inventor: Viktor Kaptelinin, Hornefors (SE)

(21) Appl. No.: 18/212,578

(22) Filed: Jun. 21, 2023

Related U.S. Application Data
(60) Provisional application No. 63/354,200, filed on Jun. 21, 2022.

(51) Int. Cl. H04L 12/18

(52) U.S. Cl. CPC H04L 12/1822; H04L 12/1831

(57) ABSTRACT

The present invention teaches methods and software, intended to help a participant in an online meeting to understand other participants more efficiently. According to one embodiment of the invention, a user of videoconferencing technology may choose the size of the panes, displayed in a window and showing information about meeting participants. According to another embodiment of the invention, meeting participant panes may be spatially arranged in a window, and the spatial structures or layouts are substantially the same for all participants in the meeting. According to yet another embodiment, a participant in a meeting, who shares a content through using a “screen share” feature, may choose including an image of the screen-shared content to the participant's self-view, which self-view is preferably displayed in a floating window when the participant switches to a computer application, different from the videoconferencing application at hand.

### CROSS-REFERENCE TO RELATED APPLICATIONS

The present application claims the benefit of provisional U.S. Patent Application Ser. No. 63/354,200, filed Jun. 21, 2022 with title “MANAGEMENT OF USER'S INCOMING IMAGES IN VIDEOCONFERENCE SESSIONS” and naming Viktor Kaptelinin as inventor.

### FEDERALLY SPONSORED RESEARCH

Not Applicable.

### BACKGROUND OF THE INVENTION

This invention relates to electronic systems and their interfaces. More specifically, it relates to information technologies that enable communication between several participants connected to each other through a computer network and using videoconferencing technologies to conduct virtual meetings (such as committee meetings, lectures, seminars, etc.).

In physical meetings, people intuitively use a diversity of perceptual clues and strategies to understand other participants and present themselves to the others. In “virtual meetings” supported by videoconferencing technologies (“virtual meetings” are also referred to as “online meetings”, which terms are used interchangeably in the context of this application), the use of such cues and strategies is limited. A person's usage of videoconferencing technologies during an online (or “virtual”) meeting, typically involves employing one or more video cameras to capture and transmitting a view (or “image”) of the person (i.e., “user view”) to other participants in the meeting. In turn, images of other participants are displayed to the user on the user's display. In the context of the present invention a view of a virtual meeting participant, which view is captured by a local (that is, located in the participant's physical environment) video camera or video cameras, and received by meeting participants, is referred to as “incoming images”. A person's view, which is viewed by a person themselves, is a “self-view”, it is both an outgoing image and an incoming image.

A potential problem with current videoconferencing systems for virtual meetings is that they do not provide sufficient support to their users for understanding other participants. The subject matter disclosed in the present invention teaches an improved support for the management of incoming images and self-images by users of videoconferencing technologies during virtual meetings.

### SUMMARY OF THE INVENTION

The present invention teaches methods, apparatuses, and software, intended to support a participant in an online meeting session in the management of incoming- and self-images, and thus help the participant (i.e., a user of a videoconferencing technology) to understand other participants and present themselves to others more efficiently. According to one embodiment of the invention, a user of videoconferencing technology may choose the size (and the corresponding level of detail) of the panes, displayed in a window and showing information about meeting participants (which information may include user views received from meeting participants) without necessarily resizing the window, so that choosing a smaller size (“zooming out”) would allow the user to get a more compact (i.e., occupying a smaller screen area) overview of meeting participants. In the context of the present invention, the panes, displayed in a window and showing information about meeting participants, are referred to as “meeting participant panes”, or just “panes”. According to another embodiment of the invention, meeting participant panes may be spatially arranged in a window, and the spatial structures/layouts are substantially the same for all participants in the meeting (which ‘means that spatial arrangements of different participants are characterized by isomorphism but are not necessarily identical). The embodiment may be implemented so meeting participant panes, displayed on a participant's display, are displayed in an area of the display, which area also displays a shared screen image (for instance, images of meeting participant panes, can be superimposed on the image of a presentation slide, screen-shared by the presenter). According to another embodiment, a participant in a meeting, who shares a content through using a “screen share” feature, may choose including an image of the screen-shared content to the participant's self-view, which self-view is preferably displayed in a floating window when the participant switches to a computer application, different from the videoconferencing application at hand. Additionally, the participant may be notified when a screen-shared image changes.

According to an embodiment of the invention, a method is provided for supporting a plurality of users using a plurality of electronic devices to engage in a videoconference session (i.e., “virtual meeting”, “videoconference session” and“virtual meeting” are used here interchangeably), said plurality of users comprises at least a first user and a second user, and said plurality of electronic devices comprises at least a first device and a second device, wherein said first user uses said first device and said second user uses said second device, wherein at least a device in said plurality of devices comprises at least a processor, a display, said display displaying an at least a display window, a microphone, and a video camera configured to be able to capture an image of the first user of said first device, wherein said plurality of devices are connected via a communication network to one another and preferably to a network server or servers, the method comprising the method steps of
detecting a user action performed by a user from said plurality of users, said user action being a request for displaying information about said plurality of users (e.g., meeting participants), said user requesting action being performed either before or during said videoconference session; and
presenting information about said plurality of users on an electronic device of said information-requesting user, said electronic device being a device from said plurality of devices.

According to another embodiment, method of claim 1, a display window of at least one first electronic device comprises a plurality of meeting participant panes (thereafter, “panes”), each pane in said plurality of panes being a graphical screen object displaying information about a user from said plurality of users.

According to yet another embodiment, said first electronic device (said processor, said memory storage, and said display) is adapted to be able to display said plurality of panes in different pane sizes without resizing said display window, wherein displaying said plurality of panes in a smaller pane size causes said plurality of panes occupy a smaller part of said display window, and displaying said plurality of panes in a larger pane size causes said plurality of panes occupy a larger part of said display window,
wherein said requesting user action is a request for displaying said plurality of panes in a requested pane size, and
wherein said detecting of said requesting user action causes displaying said plurality of panes in said requested pane size.

According to an embodiment of the invention, at least a device from said plurality of electronic devices is adapted to be able to display in a display window a plurality of panes in different pane sizes without resizing said display window, whereby displaying said plurality of panes in a smaller pane size causes said plurality of panes occupy a smaller part of said display window, and displaying said plurality of panes in a larger pane size causes said plurality of panes occupy a larger part of said display window.

According to another embodiment, the requested pane size is defined as a size, which is a largest possible pane size that allows displaying said plurality of panes in said display window in one view (i.e., so that all panes of said plurality of panes can be viewed in said display window without a need to scroll said display window), and
wherein if a largest pane size allowing displaying said plurality of panes in one view is smaller than a smallest available pane size, then displaying said plurality of panes in the smaller pane size, else displaying said plurality of panes in a largest possible pane size that allows displaying said plurality of panes in said display window in one view.

According to another embodiment, the plurality of panes are displayed in said display window according to a spatial arrangement, and a structure of said spatial arrangement in said display window is substantially constant throughout the duration of said videoconference session (spatial arrangements of said plurality of panes, at different points of time throughout said videoconference session, are characterized by isomorphism). According to a variation of this embodiment, the spatial arrangement in said display window on said first electronic device is structurally similar to a spatial arrangement of panes in a display window on at least said second user, so that on each other electronic device from said plurality of electronic devices the spatial arrangements are characterized by isomorphism, or structure preserving mapping.

According to another embodiment, the first user is enabled to cause a preferably scaled down visual representation of an image shared by said first user (e.g., using a “‘screen share” functionality) to be displayed on said first electronic device (preferably, in a floating meeting participant pane when a videoconference application window is not active on said first device).

### BRIEF DESCRIPTION OF THE DRAWINGS

FIGS. 1a-1c: Illustrate an embodiment according to the present invention.

FIG. 2: Illustrates an embodiment according to the present invention.

FIG. 3: Illustrates an embodiment according to the present invention.

FIG. 4: Illustrates an embodiment according to the present invention.

FIGS. 5a-5c: Illustrate an embodiment according to the present invention.

FIGS. 8a-8e: Illustrate an embodiment according to the present invention.

### DETAILED DESCRIPTION OF THE INVENTION

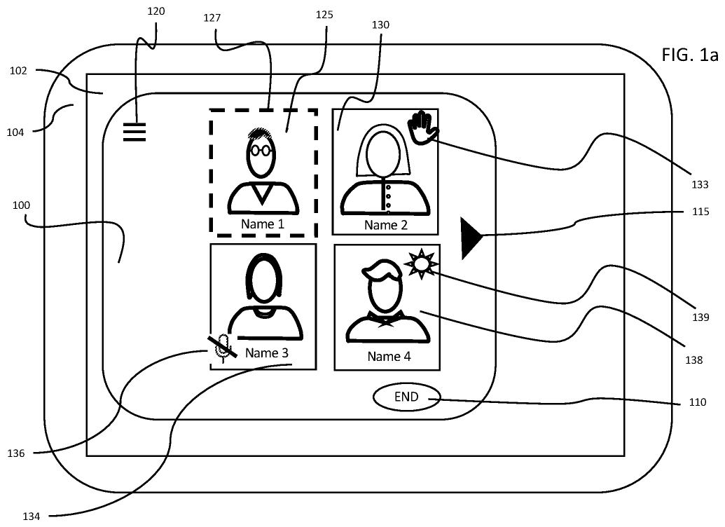

FIGS. 1-5 and FIG. 8 illustrate several embodiments of the present invention. The embodiments are intended to support a participant in an online meeting in the management of incoming- and self-images, and thus help the participant (i.e., a user of a videoconferencing technology) to better understand meeting participants. Before describing the embodiments, the following terms, issued in the disclosure below, are defined: “participant view”, “self-view”, “screen-shared” image, “meeting participant pane” (or “pane”), and “device.

When a person takes part in an online (or “virtual”) meeting, supported by the use of a videoconferencing technology, the person is typically presented with “participant views”. A Participant view is information about a meeting participant, displayed to the person on the display of a person's computing device (such as a computer or a smartphone). A participant view may include an image of the participant, a name of the participant, a visual cue or cues indicating participants' status or statuses (e.g., muted/unmuted, camera on/off, etc.), visual cue or cues indicating (e.g., temporary) participant's actions (e.g., posting a new chat message, raising a hand, applauding, etc.), or a combination thereof, as well as potential additional types of information. An image of a participant may include a camera view (a video stream showing a view of the participant, captured by a camera in the participant's physical environment) or a still picture of the participant (e.g., a picture, predefined by the participant, displayed when a camera view is turned off). In some cases, a participant image may be blank.

There are two types of participant views. First, there are participant views of other participants in the meeting, A participant view of this type comprises information about another meeting participant, received by a person and displayed on the receiving person's device. The second type is a person's “self-view”, that is, a person's view (including, e.g., a video image captured by a person's own camera), which is displayed to the person themselves. A self-view may be used by a person to see how she or he is viewed by other meeting participants. A participant view may not only be a view of one particular person, but it can also be a view of several persons, e.g., several people using the same device or the same videoconference-enabled room.

In addition to sending and receiving their views, participant in virtual meetings can also stream other types of images. For instance, a presenter may share an image of a presentation slide or show a video to other participants. In the context of this application, this type of content is referred to as “screen shared”. It is understood that the term “screen-shared” is not limited to content, streamed to other participants using a “screen share” command, but includes various types of media (images and sounds, potentially including other modalities), shared by a meeting participant and viewed in substantially real time by other meeting participants.

A “meeting participant pane” (“MP-pane”, or “pane”) is a graphical screen object of a certain shape (e.g., a rectangle) and size, which object is displaying a participant view (i.e., information about a meeting participant—see above). Meeting participant panes are window elements, which may be gathered in one window area, and displayed close to each other in the area (for instance, as tiles). In the description below panes will be referred to as “window elements”. In the context of the description below the terms “meeting participant pane”, “MP-pane”, “pane”, and “window element” will be used interchangeably.

Size management of MP-panes comprises two complementary user actions: increasing actions (increasing the size of MP-panes) and reducing actions (reducing the size of MP-panes). A reducing action causes a decrease of the screen space occupied by several MP-panes or an individual pane. MP-pane reducing methods can be of several types. A “scaling down” reducing method is producing a smaller version of the same graphical screen object, which may be a lower-resolution image or a smaller image of the same resolution. An “omitting” reducing method is displaying fewer types of information about the participant: e.g., a reduced MP-pane may display the name of a participant, but no longer display an image of the participant; or a further diminished MP-pane may display participant's initials instead of a participant's full name. “Scaling down” and “omitting” reducing methods may be combined within the same reducing action: e.g., a reducing action may produce a smaller MP-pane, which comprises a smaller (scaled down) image of the participant and omit participant's last name, only displaying the first name and an initial instead of the last name. A reducing action may or may not preserve or change the shape of an MP-pane.

An outcome of an increasing action is opposite to that of a reducing action. As a result of an increasing action is an increased size of MP-panes, e.g., by scaling up MP-pane images, adding more detail, or both. An increasing action or a reducing action may be applied to all MP-panes in a window, a sub-set of MP-panes in a window, or an individual MP-pane. When an increasing action or a reducing action is applied to a set of MP-panes, it may result in increasing or decreasing of the screen space occupied by the entire set of MP-panes. For instance, if a reduced action is performed in relation to all MP-panes in a computer application window, the MP-panes may become smaller while staying close to one another, so the whole area occupied by the MP-panes is “shrinking” (as if the user performed a “zoom out” action).

Changes of MP-panes, resulting from an increasing action or a reducing action, may be virtually continuous or discrete. Virtually continuous changes may be made through multiple small-increment transitions within the entire range between the smallest size and the largest size of MP-panes. For instance, the smallest and the largest sizes of MP-panes can be 20×20 pixels and 200×200 pixels, and the scaling up/scaling down actions may result in “one pixel at a time” enlarging/shrinking of MP-pane images, similar to “zooming in” and “zooming out”.

Discrete changes are made in predefine steps: several specific MP-pane sizes (and corresponding levels of detail) are selected as points on a scale (or gradations) from the smallest to the largest MP-pane sizes, and increasing/reducing actions will result in step-wise transitions between the sizes.

For instance, the following four gradations of MP-pane sizes can be predefined:
the largest size MP-panes may include a large area with a participant camera view area, a participant's full name in a large-font text, and large visual cues (status and activity); the MP-panes have a general shape of a vertically-oriented rectangle (with its height exceeding its width).

One step smaller are MP-panes which are “shrank” versions of the largest size MP-panes; the next-largest MP-panes include a small area with a participant camera view area, a participant's full name in a small-font text, and slightly smaller visual cues (status and activity).

One more step smaller are MP-panes which do not include a participant camera view area, and show a participant's full name in the same font size as at the previous step, and visual cues (status and activity) in the same size as at the previous step; the shape of MP-panes changes to a horizontally-oriented rectangle (with its width exceeding its height).

Of the smallest size are MP-panes, which include a participant's initials in the same font size as at the previous step, and visual cues (status and activity) in the same size as at the previous step; the shape of MP-panes changes to a square-like shape.

Other types of size gradations can be defined, for instance, as ready-made gradations presented to meeting participants as options to choose. Alternatively, certain types of size gradations can be defined by meeting participants themselves.

To choose an appropriate size of MP-panes, meeting participants can be enabled to use either one-step directional transition commands (e.g., “larger” and “smaller”, similar to “zoom in/out”), or directly choose the size then want to have (e.g., selecting an item from a menu comprising “large pics”, “small pics”, “names”, and “initials”).

FIGS. 1-4 illustrate the first embodiment of the invention. The embodiment teaches enabling the user of an electronic device, who is using the device to take part in a virtual meeting, to select the level of detail when displaying participant views. FIG. 1a shows window 100 displayed on display 102 of electronic device 104. Device 104 is a computing device having a display, such as a tablet computer, a laptop computer, or a smartphone. Device 104 is used by user “Name 1” to take part in a virtual meeting. User “Name 1” is having host privileges, which include the power of ending the meeting. Window 100 is a simplified schematic representation of an application window of a videoconferencing software program, as it is seen by user “Name 1”. Various user interface elements, obvious to those skilled in the art and typically used in videoconferencing programs, are not displayed to provide a clearer focus on the subject matter of the current invention. Window 100 comprises four window elements (panes) 125, 130, 134, and 138, which show participant views of, respectively, participant “Name 1”, participant “Name 2”, participant “Name 3”, and participant “Name 4”. Window elements (panes) 125, 130, 134, and 138 are rectangular areas constituting “tiles”, or “panes”. Each window element shows an image of the participant in question (a camera view or a still image, e.g., from the participant's profile) and the name of the participant. In addition, window element 125 comprises visual cue 127 (a broken outline/contour line) indicating that participant “Name 1” is the user of device 104 and window area 125 shows a self-view of participant “Name 1”. Window element 130 comprises visual cue 133 (a raised hand image) indicating that participant “Name 2” wants to get the floor. Window element 134 comprises visual cue 136 (a “struck through microphone” image) indicating that participant “Name 3” is muted. Window element 138 comprises visual cue 139 (a star) indicating that participant “Name 4” sent a chat message.

Screen button (or “icon”) 120 can be activated (e.g., by clicking or tapping it) to open menu 122 (menu 122 is not shown in FIG. 1c, please see FIG. 1c). Screen button 110 can be activated by user “Name 1” to end the virtual meeting. Because of limited screen space, window 100 does not display participant views of all participants in the meeting. To see more participant views, participant “Name 1” has to activate screen button/icon 115, which would cause more participant views to be shown in window 100 (from participant “Name 1” perspective, activating button 115 causes participant views scroll to the right).

FIG. 1b shows a view of window 100 after screen button 115 has been activated. Four new participant views are shown in window elements (panes) 150, 154, 160, and 164, which are participant views of, respectively, participants “Name 5”, “Name 6”, “Name 7”, and “Name 8”. Button 115 is no longer displayed, as there are no more non-displayed participant views, and “Name 1” cannot scroll participant views further to the right. Instead, button 116 is displayed in window 100. Activating button 116 would scroll participant view to the left, back to the view shown in FIG. 1a.

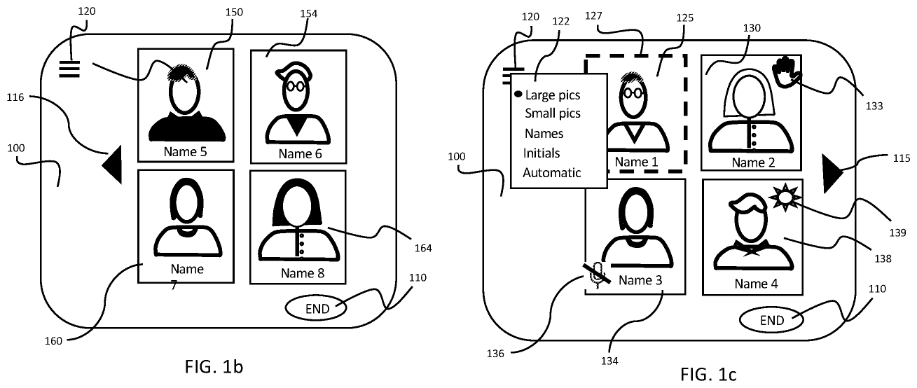

FIG. 1c is similar to FIG. 1a; the difference from FIG. 1a is that FIG. 1c shows the view of window 100 after button 120 has been activated. Activating button 120 results in menu 122 popping up. Menu 122 comprises several items: Large pics, Small pics, Names, Initials, and Automatic. Items in menu 122 describe several options for displaying participant views in window 100. The current selection is “Large pics”, which describes how participant views are are presented in window 100: participant views are displayed in larger display areas, and full names in larger font size are shown. As shown in FIGS. 2-5 below, when other options are selected, participant views in window 100 are displayed differently.

FIG. 2 shows how participant views of the same participants as those shown in FIG. 1, are displayed in window 100 when the “Small pics” option is selected on menu 122 (see FIG. 1c). Participant views are displayed in window elements (panes) 200 (participant “Name 1”), 210 (participant “Name 2”), 220 (participant “Name 3”), 230 (participant “Name 4”), 240 (participant “Name 5”), 250 (participant “Name 6”), 260 (participant “Name 7”), and 270 (participant “Name 8”). Visual cues 205, 215, 225, and 235 are smaller versions of, respectively, visual cues 127, 133, 136, and 139, shown in FIG. 1a and FIG. 1c. Since window elements (panes) displaying participant views are smaller when the “Small pics” option is selected, FIG. 2 shows participant view of all meeting participants to be simultaneously displayed in window 100.

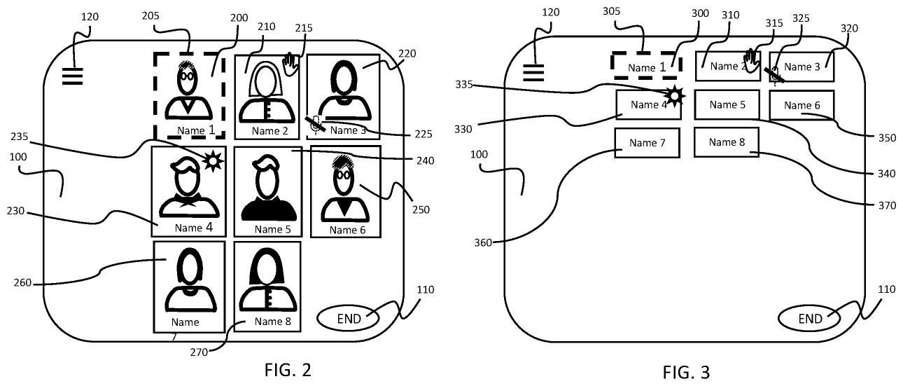

FIG. 3 shows how participant views of the same participants as those shown in FIG. 1 and FIG. 2, are displayed in window 100 when the “Names” option is selected on menu 122 (see FIG. 1c). Participant views are displayed in window elements (panes) 300 (participant “Name 1”), 310 (participant “Name 2”), 320 (participant “Name 3”), 330 (participant “Name 4”), 340 (participant “Name 5”), 350 (participant “Name 6”), 360 (participant “Name 7”), and 370 (participant “Name 8”). The participant views show the names, but not images, of the participants. Visual cues 305, 315, 325, and 335 are smaller versions of, respectively, visual cues 127, 133, 136, and 139, shown in FIG. 1a and FIG. 1c. Window elements (panes) 300, 310, 320, 330, 340, 350, 360, and 370 are smaller than window elements (panes) 200, 210, 220, 230, 240, 250, 260, and 270, shown in FIG. 2. Accordingly, window elements (panes) 300, 310, 320, 330, 340, 350, 360, and 370 take up a smaller part of window 100 than window elements (panes) 200, 210, 220, 230, 240, 250, 260, and 270, shown in FIG. 2.

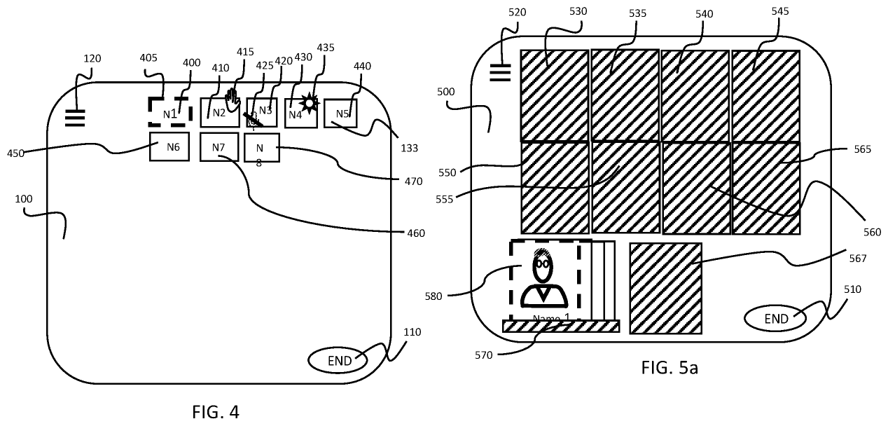

FIG. 4 shows how participant views of the same participants as those shown in FIG. 1, FIG. 2, and FIG. 3 are displayed in window 100 when the “Initials” option is selected on menu 122 (see FIG. 1c). Participant views are displayed in window elements (panes) 400 (participant “Name 1”), 410 (participant “Name 2”), 420 (participant “Name 3”), 430 (participant “Name 4”), 440 (participant “Name 5”), 450 (participant “Name 6”), 460 (participant “Name 7”), and 470 (participant “Name 8”). Visual cues 405, 415, 425, and 435 are similar to visual cues 305, 315, 325, and 335, shown in FIG. 3. Window elements (panes) 400, 410, 420, 430, 440, 450, 460, and 470 are even smaller than window elements (panes) 300, 310, 320, 330, 340, 350, 360, and 370, shown in FIG. 3. Accordingly, window elements (panes) 400, 410, 420, 430, 440, 450, 460, and 470 take up a smaller space, and a smaller part of window 100, than window elements (panes) 300, 310, 320, 330, 340, 350, 360, and 370, shown in FIG. 3.

When the “Automatic” item is selected on many 122 (FIG. 1c), the level of detail in presenting participant views is selected using the following method: participant views should be presented in as much detail as possible (or “as detailed as possible”, or “the highest possible level of detail”), which would make the participant views to fit into the available screen space allocated for participant views. For the meeting illustrated in FIGS. 1-4, it will be the “Small pics”. “Large pics” views provide more detail level but do not fit into the available space and the user needs to scroll to see all views. “Names” and “Initials” also fit into available space, but they provide less detail than “Small pics”. If even participant views do not fit into the available space even if the lowest level of detail is selected (in the present case, “Initials”), participant views will be presented at the lowest level and the user will be able to scroll the views to see all meeting participants.

A ramification of the first embodiment includes allowing the user to “Zoom in” on certain areas of a lower-resolution presentation of participant views, that is, enabling the user to selectively display more detailed (“enlarged”) views of certain participants or groups of participants (while other participants are still presented in lower resolution). For instance, hovering the pointer over window element 420 (FIG. 4) may cause a pop-up panel showing window element 134 (FIG. 1a), with a more detailed view of participant “Name 3”, will pop up. Another option is for the user to select a sub-set of participant views, and then select the level of detail for this, and only for this, sub-set.

Yet another ramification is to present participant views and a screen-shared image within the same screen area. For instance, a semi-transparent image of a presentation slide screen-shared by one of the participants, can be superimposed on participant views, or a semi-transparent image of participant views can be superimposed on a presentation slide, screen-shared by one of the participants.

It is understood that the gradation of the level of detail in presenting participant views, shown in FIGS. 1-4 (“Large pics”, “Small pics”, “Names” and “Initials”) is only used for illustration. Other names of menu items, as well as other types of gradation, or scales, or degrees, of the level of detail, are all within the scope of the present invention. For instance, there can be a “Medium pics” level, intermediate between “Large” and “Small”, can be added, or “Names” can be divided into “Large (font) names” and “Small (font) names”, etc. There are also many other variations, obvious to those skilled in the art.

It is also understood that some participants may not have a permission to end a meeting (e.g., by using a button similar to button 110 “End”). Instead, they may be able to leave a meeting (e.g., by pressing a button “Leave”).

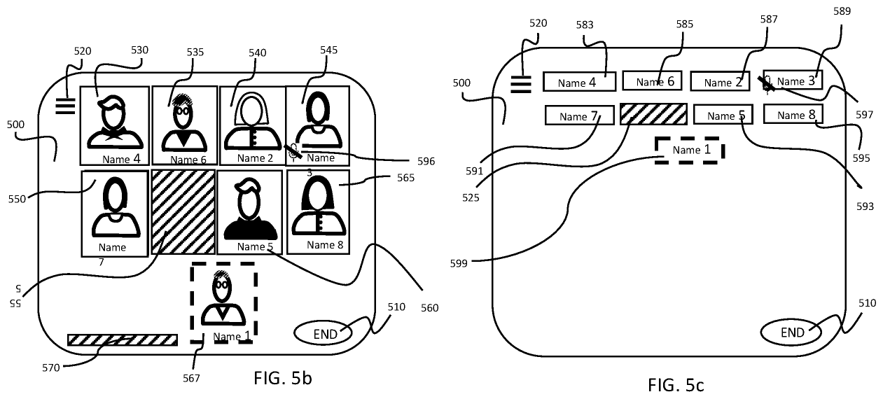

FIG. 5 shows the second embodiment of the invention. The embodiment teaches an arrangement of participant views of participants in a meeting according to a spatial layout, which layout is shared by all meeting participants. FIG. 5a shows window 500 of a computing device, representing the perspective of user “Name 1”. Window 500 shows button 510, button 520, window elements (panes) 530, 535, 540, 545, 550, 555, 560, 565, and 567, as well as temporary placement area 570. Button 210 and button 520 are functionally identical to buttons 110 and 120, shown in FIGS. 1-4: activating buttons 510 and 520 results, respectively, in ending the meeting and choosing the level of detail when displaying participants view in window 500. The spatial layout for window elements (panes) 530, 535, 540, 545, 550, 555, 560, 565, and 567, shown in FIG. 5, is a variety of a typical “classroom” layout, which comprises the following structure of places to be taken by meeting participants: two rows of four places each (“seats” for the audience) and one place located in front of the rows (a “pulpit” for a teacher or presenter). Window elements (panes) 530, 535, 540, 545, 550, 555, 560, 565, and 567, are not selected (“taken”) by meeting participants and display placeholders. Temporary placement area 570 is provided for participants, who join a meeting but do not take a place yet. When a participant joins a meeting, she/he is automatically placed in area 570, with their self-image being displayed in area 570. After that, the participant may place their participant view (self-image) to one of the window elements, which are not taken yet by other participants and display placeholders. Placing one's self-image to a window element displaying a placeholder can be achieved, for instance, by clicking or tapping the desired window element or dragging their self-image to the desired window element. FIG. 5 also shows four participant views, stacked in area 570. Self-image of user “Name 1” is displayed on top of the stack shown in area 570. Other participants, whose participant views are stacked in a temporary placing area, see their own self images displayed on top of a stack shown in the area.

FIG. 5b shows window 500 when all meeting participants have selected their desired places. Since there are nine places and only eight meeting participants, one place is not taken, and a placeholder is shown in window element 555 instead of a participant's view. No participant views are shown in temporary placement area 570. FIG. 5c shows a combination of the first and the second embodiments of the invention. FIG. 5c shows window 500 when the “Name” option is selected from menu 520. Participant views are displayed in window elements (panes) 583, 585, 587, 589, 591, 593, 595, and 599. A placeholder shown in window element 525.

It is understood that the user of a system according to the present invention (e.g., a meeting host) may choose or create different types of participant view layouts. For instance, instead of the layout shown in FIG. 5 (two rows of 4 places each with a presenter's place in front of them), there may be two square-shaped clusters of 4 seats with a presenter's place in front of them, or one circular or elliptical layout, as if all participants take seats around a round table. Numerous other layouts can be pre-defined to choose from, or constructed, by meeting participants.

Participant view layouts can be adjusted to the number of meeting participants. For instance, before starting a meeting the host can choose a layout depending on how many participants have turned out. If there are extra places, which are not taken (empty places), then can be deleted. And if more participants show up, so that the number of existing places is not sufficient, a layout can be changed to provide more places.

While a preferable option is for one place to be taken by only one participant, it is also possible that one seats can be allowed to be taken by a group of participants. In that case the participant view can present one person from the group (a representative) and marked as a “group view. The group may create their own sound space (voice communication “bubble”), with all group members, except for the representative, to be heard only by members of the group, but not other meeting participants (the use of a headset by the representative may be mandatory in that case).

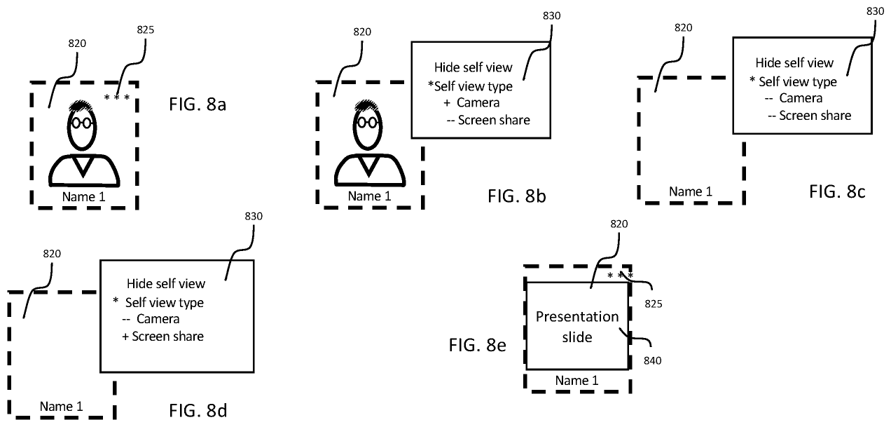

FIG. 8 shows the third embodiment of the invention. The embodiment teaches enabling meeting participants who share their screens to include a screen-shared image in their self-view. FIG. 8a shows window element 820, which displays an image and the name of participant “Name 1”. Window element 820 is similar to window element 125 (FIG. 1a). The difference is that Window element 820 includes icon 825. Activating icon 825 (e.g., by clicking or tapping) causes displaying pop-up menu 830, shown in FIG. 8b. Menu 830 includes the option of hiding self-view (no self-view is shown), and if this option is not selected, then choosing (a) whether or not to display a camera view of the participant (“Camera+/−)), and (b) whether or not to display the image, which is screen-shared by the participant (Screen-share+/−). If no image is screen-shared, then the “Screen share” item is disabled. The current selection is displaying a self-view, which includes a camera view, but does not include a screen-shared image. FIG. 8c shows participant “Name 1” self-view when “no camera” and “no screen share” options are selected. Window element 820 shows the name of the participant and a blank image. A blank image is displayed because the participant does not have a profile picture. If there were a profile picture, it would e displayed in window element 820. FIG. 8d shows a moment when participant “Name 1” uses menu 830 to choose the option of displaying screen shared image. FIG. 8e shows window element 820 displaying shared image 840. If both the option of displaying camera view and the option of displaying screen-shared image were selected, window element 820 would show both camera view and screen-shared image (not shown in FIG. 8).

It is understood that FIGS. 1-5 and FIG. 8 are used by way of illustration, and not limitation. Various additional variations are obvious to those skilled in the art and are therefore within the scope of the present invention: While the current disclosure concerns virtual meetings, it is obvious to those skilled in the art that the scope of the invention covers all kind of communication sessions, including, for instance, non-interactive lectures. Various kinds of devices can be used in accordance with the present invention, including (but not limited to) desktop computers, laptop computers, smartphones, and tablet computers. Such devices may comprise one of several components, such as cameras, displays, microphones, memory storages, processors, input devices, and so forth. The components can be both built in and external/connected. Memory storage and data processing according to the present invention may be distributed between user devices and a server or servers, connected via a communication network.

It is understood that when the same layout of participant views is shared by substantially all participants in a meeting, it does not mean that the participant views, which are presented to different participants, should be identical. It is sufficient that they have the same structure (or are “isomorphically equivalent”). For instance, participant views shown in FIG. 5b (shown to participant “Name 1”) and FIG. 7b (shown to participant “Name 4”) are different, as there are different levels of detail and different additional visual cues are displayed (e.g., visual cues indicating self-view). However, participant views in FIG. 5b and FIG. 7b have the same structure, and it can be stated that participants “Name 1” and “Name 4” have a shared layout of participant views.

What is claimed is:

1. A method is provided for supporting a plurality of users using a plurality of electronic devices to engage in a videoconference session (i.e., “virtual meeting”, “videoconference session” and“virtual meeting” are used here interchangeably), said plurality of users comprises at least a first user and a second user, and said plurality of electronic devices comprises at least a first device and a second device, wherein said first user uses said first device and said second user uses said second device, wherein the first device and at least a second device in said plurality of devices comprise at least a processor, a display, said display displaying an at least a display window, a microphone, and a video camera configured to be able to capture an image of the first user of said first device, wherein said plurality of devices are connected via a communication network to one another and preferably to a network server or servers, wherein said display window of at least said first electronic device comprises a plurality of meeting participant panes (thereafter, “panes”), each pane in said plurality of panes being a graphical screen object displaying information about a user from said plurality of users, the method comprising the method steps of
presenting information about said other users from said plurality of users in said panes on said display of said first device, wherein said first electronic device is being adapted to be able to display said plurality of panes in different pane sizes without resizing said display window, wherein displaying said plurality of panes in a smaller pane size causes said plurality of panes occupy a smaller part of said display window, and displaying said plurality of panes in a larger pane size causes said plurality of panes occupy a larger part of said display window, and
detecting a user action performed by a user of the said first device, wherein said requesting user action is a request for displaying said plurality of panes in a requested pane size, and
wherein said detecting of said requesting user action causes displaying said plurality of panes in said requested pane size.

2. A method of claim 1, wherein said requested pane size is defined as a size, which is a largest possible pane size that allows displaying said plurality of panes in said display window in one view (i.e., so that all panes of said plurality of panes can be viewed in said display window without a need to scroll said display window), and
wherein if a largest pane size allowing displaying said plurality of panes in one view is smaller than a smallest available pane size, then displaying said plurality of panes in the smaller pane size, else displaying said plurality of panes in a largest possible pane size that allows displaying said plurality of panes in said display window in one view.

3. A method of claim 1, wherein said plurality of panes are displayed in said display window according to a spatial arrangement, and a structure of said spatial arrangement in said display window is substantially constant throughout the duration of said videoconference session (spatial arrangements of said plurality of panes, at different points of time throughout said videoconference session, are characterized by isomorphism).

4. A method of claim 3, wherein said spatial arrangement in said display window on said first electronic device is structurally similar to a spatial arrangement of panes in a display window on at least said second user (or “on each other electronic device from said plurality of electronic devices) (the spatial arrangements are characterized by isomorphism, or structure preserving mapping).

5. A method of claim 1, wherein said requesting user action is a question, verbally asked by said first user, using an audio or a video communication channel, to at least said second user (or several users), wherein substantially at the time of asking said question said first participant performs a user action causing displaying a response screen object on at least said second electronic device (or several devices), wherein said response screen object enables at least said second user (or several users) to choose a response to said question through a user action (such as clicking on a certain clickable button), said response of at least second user (or several users) being displayed to said first user (preferably, anonymously) on said display of said first electronic device.

6. A method of claim 1, wherein at least said second user (or several users) is provided with a response panel displayed on said second electronic device, to continuously provide responses during said videoconference session or a part of said session, at time or times of their choosing, to dynamically assess an aspect of said videoconference session (such as a presentation given by said first user), wherein said responses, summarized and preferably anonymized, are continuously displayed on said display of said first user.

7. A method of claim 1, wherein at least said first user is enabled to cause a preferably scaled down visual representation of an image shared by said first user (e.g., using a “‘screen share” functionality) to be displayed on said first electronic device (preferably, in a floating meeting participant pane when a videoconference application window is not active on said first device).

8. A non-transitory computer-readable medium containing instructions, which, when executed by a processor, cause a first electronic device, said first device comprising at least a processor, a memory storage, a display, a microphone, and a video camera, said device being connected via a communication network to a plurality of electronic device used by a plurality of users taking part in a videoconference session and connected to a network server or servers, said first electronic device adapted to show, in a display window of said display of said first device, a plurality of meeting participant panes (thereafter, “panes”), said panes being graphical screen objects displaying information about at users from said plurality of users, and preferably also about user of said first device, to perform functions of:
detecting a user action performed by a user of said first device, said user action being a request for displaying information about said plurality of users (e.g., meeting participants); and
presenting information about said plurality of users on said electronic device of said first user; and
displaying said plurality of panes in different pane sizes without resizing said display window, wherein displaying said plurality of panes in a smaller pane size causes said plurality of panes occupy a smaller part of said display window, and displaying said plurality of panes in a larger pane size causes said plurality of panes occupy a larger part of said display window, and
detecting a requesting user action being a request for displaying said plurality of panes in a requested pane size, and
displaying said plurality of panes in said requested pane size.

9. A non-transitory computer-readable medium of claim 8, wherein said requested pane size is defined as a size, which is a largest possible pane size that allows displaying said plurality of panes in said display window in one view, so that all panes of said plurality of panes can be viewed in said display window without a need to scroll said display window, said medium further containing instructions, which, when executed by a processor, cause said first electronic device to perform functions of:
detecting whether a largest pane size allowing displaying said plurality of panes in one view is smaller than a smallest available pane size,
if a largest pane size allowing displaying said plurality of panes in one view is smaller than a smallest available pane size, then displaying said plurality of panes in the smaller pane size,
if a largest pane size allowing displaying said plurality of panes in one view is not smaller than a smallest available pane size, then displaying said plurality of panes in a largest possible pane size that allows displaying said plurality of panes in said display window in one view.

10. A non-transitory computer-readable medium of claim 8, further containing instructions, which, when executed by a processor, cause said first electronic device to perform functions of:
displaying said plurality of panes in said display window according to a spatial arrangement, so that a structure of said spatial arrangement in said display window is substantially constant throughout the duration of said videoconference session (spatial arrangements of said plurality of panes, at different points of time throughout said videoconference session, are characterized by isomorphism); and
making sure said spatial arrangement in said display window on said first electronic device is structurally similar to spatial arrangements of panes in display windows on said plurality of electronic devices (or “on each other electronic device from said plurality of electronic devices) (the spatial arrangements are characterized by isomorphism, or structure preserving mapping).

11. A non-transitory computer-readable medium of claim 8, further containing instructions, which, when executed by a processor, cause said first electronic device to perform functions of:
detecting user action by said first user, said user action being a request to add or delete an image shared by said first user (e.g., using a “‘screen share” functionality) to/from said user's self-view pane; and
adding or deleting a, preferably scaled down, visual representation of the image shared by said first user to/from a self-view pane of said first user, said self-view pane being displayed on said first electronic device (preferably, in a floating window displayed when a videoconference application window is not active on said first device).
